(19) United States
(12) Patent Application Publication
(10) Pub. No.: US 2002/0165950 A1
(43) Pub. Date: Nov. 7, 2002

(54) Home appliance networking system and method for controlling the same

(76) Inventors: Sang Kyun Lee, Kwangmyung-si (KR); Ki Tae Oh, Kwangmyung-si (KR); Yeon Kyung Lee, Koyang-si (KR); Chang Ho Kim, Seoul (KR)

Correspondence Address: BIRCH STEWART KOLASCH & BIRCH, PO BOX 747, FALLS CHURCH, VA, 22040-0747, US

(21) Appl. No.: 10/124,349

(22) Filed: Apr. 18, 2002

(30) Foreign Application Priority Data
May 2, 2001 (KR) 2001-23861

(51) Int. Cl. G06F 15/173

(52) U.S. Cl. 709/223

(57) ABSTRACT

A home appliance networking system and a method for controlling the same. At least one home appliance is connected to a network and controlled in response to control information received over the network and transmits its state information and self-information over the network. An agent is connected to the home appliance to recognize the self-information transmitted from the home appliance and manage transmission and reception of all data over the network by the appliance on the basis of the recognized information. A service provider provides additional information regarding the home appliance, not included in the self-information of the appliance, to the agent. If a new home appliance is connected to the network to which other home appliances remain connected, the agent recognizes all information of the new home appliance and manages transmission and reception of all data over the network by the appliance on the basis of the recognized information. As a result, whenever a new home appliance is connected to the network, it need not exchange data with other home appliances connected to the network, thereby enabling data to be efficiently transmitted and received over the network.

### BACKGROUND OF THE INVENTION

1. Field of the Invention

The present invention relates to home appliance networking systems and methods for controlling the same, and more particularly to a home appliance networking system and a method for controlling the same, wherein communication mediation means can automatically recognize self-information of home appliances connected to a network and additional information regarding the home appliances and manage transmission and reception of data over the network on the basis of the recognized information.

2. Description of the Related Art

With the development of Internet networks, recently, most home appliances have been made to be of a multifunction type having several additional functions as well as their original functions. For example, some home appliances may be equipped with local area network (LAN) cards or modems such that they not only transmit and receive data over communication networks, but also are automatically upgraded in version. Operations of such home appliances can also be controlled from any communicatable places outside of their installed places.

Generally, communication devices are installed respectively in home appliances to transfer signals between the home appliances and transmit and receive those signals via a communication cable. Also, through the use of a communication connection service provided by an Internet service provider (ISP), an external remote system can gain access to a specific home and control home appliances therein. Service centers for such home appliances can update programs associated with the home appliances while transmitting and receiving various data to/from the home appliances through the communication connection service.

FIG. 1 shows the construction of a conventional home appliance networking system. As shown in this drawing, the conventional home appliance networking system comprises a plurality of networkable home appliances 2a, 2b and 2c installed in each home and assigned Internet protocol (IP) addresses, respectively, such that they are controlled from external remote places, and transmit and receive data over a communication network, and communication mediation means 1 for managing the data transmission and reception over the communication network to enable communication among the plurality of networkable home appliances 2a, 2b and 2c.

However, the above-mentioned conventional home appliance networking system has a disadvantage in that, each time a new home appliance is connected to the existing communication network, all the home appliances connected to the communication mediation means must exchange their self-information with one another to identify one another, resulting in an increase in data traffic of the network.

### SUMMARY OF THE INVENTION

Therefore, the present invention has been made in view of the above problem, and it is an object of the present invention to provide a home appliance networking system and a method for controlling the same, wherein communication mediation means can efficiently recognize self-information provided from home appliances connected to a network and additional information regarding the home appliances, provided from a service provider storing the additional information, and manage transmission and reception of data over the network on the basis of the recognized information.

In accordance with one aspect of the present invention, the above and other objects can be accomplished by the provision of a home appliance networking system comprising: at least one home appliance connected to a network, the home appliance being controlled in response to control information received over the network and transmitting its state information and self-information over the network; and communication mediation means connected to the home appliance for recognizing the self-information transmitted from the appliance and managing transmission and reception of all data over the network by the appliance on the basis of the recognized information.

In accordance with another aspect of the present invention, there is provided a method for controlling a home appliance networking system, comprising the steps of: a) allowing communication mediation means managing transmission and reception of data over a network to determine whether there is a new home appliance connected to the network and, if there is the new home appliance connected to the network, request the new home appliance to transmit its self-information; b) allowing the home appliance to transmit its self-information to the communication mediation means in response to the request therefrom; and c) allowing the communication mediation means to recognize the self-information transmitted from the home appliance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a conventional home appliance networking system;

FIG. 2 is a block diagram showing the construction of a home appliance networking system in accordance with a first. embodiment of the present invention;

FIG. 3 is a block diagram showing the construction of a home appliance networking system in accordance with a second embodiment of the present invention;

FIG. 4 is a flow chart illustrating a method for controlling the home appliance networking system in accordance with the first embodiment of the present invention; and

FIG. 5 is a flow chart illustrating a method for controlling the home appliance networking system in accordance with the second embodiment of the present invention.

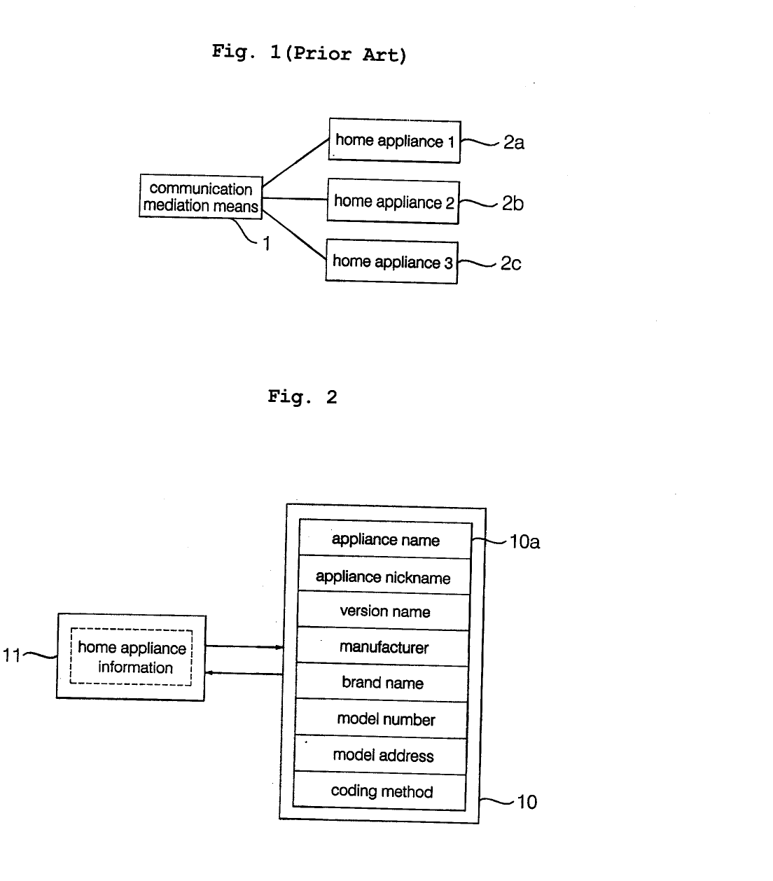

### DESCRIPTION OF THE PREFERRED EMBODIMENTS

FIG. 2 shows the construction of a home appliance networking system in accordance with a first embodiment of the present invention. As shown in this drawing, the home appliance networking system comprises at least one home appliance 10 connected to a network. The home appliance 10 is controlled in response to control information received over the network and transmits its state information and self-information 10a over the network. An agent, or communication mediation means, 11 is connected to the home appliance 10 to assign an address to the home appliance 10, recognize the self-information 10a transmitted from the appliance 10 and manage transmission and reception of all data over the network by the appliance 10 on the basis of the recognized information.

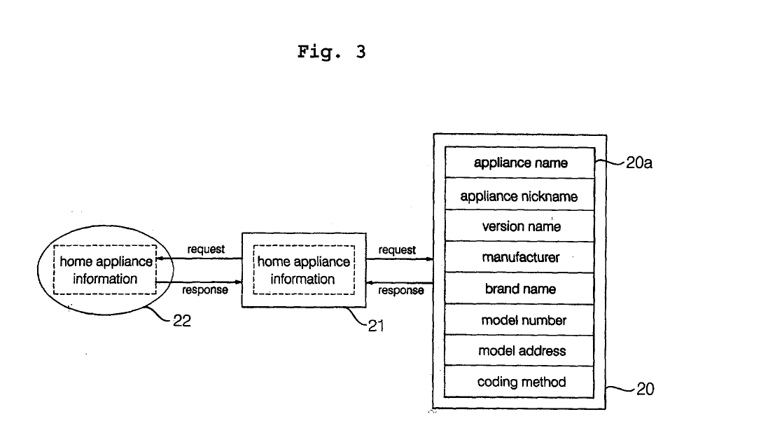

FIG. 3 shows the construction of a home appliance networking system in accordance with a second embodiment of the present invention. As shown in this drawing, the home appliance networking system comprises at least one home appliance 20 connected to a network. The home appliance 20 is controlled in response to control information received over the network and transmits its state information and self-information 20a over the network. The home appliance networking system further comprises an agent, or communication mediation means, 21 connected to the home appliance 20 for assigning an address to the home appliance 20, recognizing the self-information 20a transmitted from the appliance 20 and additional information regarding the appliance 20 and managing transmission and reception of all data over the network by the appliance 20 on the basis of the recognized information, and a service provider 22 for providing the additional information regarding the home appliance 20, not included in the self-information 20a of the appliance 20, to the communication mediation means 21 in response to a request therefrom.

In the first and second embodiments of the present invention, each of the agents 11 and 21 preferably includes address management means (not shown) for assigning a logical identification (ID) to the home appliance on the basis of a unique hardware ID assigned to the appliance when the appliance is connected to the network. The agent manages transmission and reception of data among a plurality of home appliances assigned logical IDs by the address management means.

Each of the self-information 10a and 20a of the home appliances 10 and 20 is preferably composed of a plurality of data items as shown in FIGS. 2 and 3. That is, each of the self-information 10a and 20a includes basic information for notifying other home appliances and the communication mediation means 11 or 21 of the existence of the home appliance 10 or 20 over the network, comprising: an appliance name indicative of a product type of the home appliance 10 or 20, such as a washing machine, TV, air-conditioner or the like; an appliance nickname indicative of a representative specific function of the home appliance 10 or 20; a version name indicative of a version of a software program contained in the home appliance 10 or 20 to operate and control the appliance 10 or 20; a manufacturer of the home appliance 10 or 20; a brand name of the home appliance 10 or 20 offered for sale to the public; a model number uniquely assigned to the home appliance 10 or 20 in a manufacturing process for identification of the appliance 10 or 20; a model address that is a uniform resource locator (URL) of the service provider 22 on the Web, which stores the additional information regarding the home appliance 10 or 20; and a coding method including text representation and format information of the additional information regarding the home appliance 10 or 20 stored in the service provider 22.

More preferably, any data items may be added or deleted to or from the self-information 10a or 20a of the home appliance 10 or 20 in the manufacturing process according to the product type and provision services of the appliance 10 or 20. Namely, a new data item may be optionally added to the self-information 10a or 20a or an existing data item may be optionally deleted therefrom. Further, the data items of the self-information 10a or 20a may be modified in their arranged order as needed.

On the other hand, the additional information regarding the home appliance 10 or 20, not included in the self-information of the appliance, may be stored in a large-capacity memory of the appliance when the appliance is a product equipped with the large-capacity memory, such as a washing machine, air-conditioner, TV or like. However, differently from such a home appliance, the storage of the additional information in a small-size, low-price simple home appliance, such as a coffee maker or toaster, imposes burdens on the home appliance in terms of a product size and product cost. In this regard, by storing the additional information of the home appliance 10 or 20 in the service provider 22 on the Web and storing the URL of the service provider 22 as the model address in the self-information 10a or 20a, the communication mediation means 11 or 21 can access the service provider with the stored model address to obtain the additional information of the home appliance 10 or 20 therefrom.

In the case where the memory of the home appliance 10 or 20 has a capacity sufficient to store the additional information as well as the self-information 10a or 20a, the model address of the self-information 10a or 20a indicates that all the information of the home appliance is stored in the appliance memory. As a result, upon receiving such self-information, the communication mediation means 11 or 21 requests the additional information from the home appliance 10 or 20, which then transmits the additional information to the communication mediation means 11 or 21.

Alternatively, in the case where the memory capacity of the home appliance 10 or 20 is insufficient to store the additional information as well as the self-information 10a or 20a, the model address of the self-information 10a or 20a indicates the URL of the service provider 22 including the additional information. As a result, upon receiving such self-information, the communication mediation means 11 or 21 requests the additional information from the service provider 22 to obtain it.

On the other hand, additional information regarding a washing machine stored in the service provider 22 may include, for example, detailed operation control specifications such as cycles and durations of washing, rinsing and spin-drying modes, a washing speed, a motor RPM, etc.

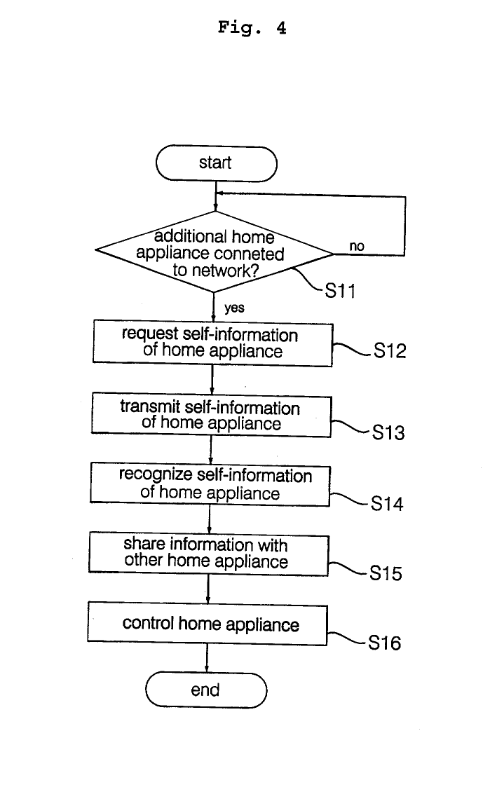

A description will hereinafter be given of a method for controlling the home appliance networking system with the above-stated construction in accordance with the first embodiment of the present invention with reference to a flow chart of FIG. 4.

First, the communication mediation means 11 continuously monitors at the first step S11 whether there is an additional home appliance 10 powered on and connected to the network. Upon determining at the first step S11 that there is no additional home appliance powered on and connected to the network, the communication mediation means 11 performs the first step S11 repeatedly.

On the other hand, if it is determined at the above first step S11 that there is the additional home appliance 10 powered on and connected to the network, the communication mediation means 11 requests the home appliance 10 to transmit its self-information 10a composed of a plurality of data items at the second step S12, so as to recognize the appliance self-information 10a and share the recognized information with other home appliances connected to the network.

At this time, the communication mediation means 11 may request the home appliance 10 to transmit the plurality of data items at one time or sequentially one by one. That is, the communication mediation means 11 may request the home appliance 10 to transmit all data of the self-information at one time or only specific data of the self-information.

In response to the request from the communication mediation means 11 at the above second step S12, the home appliance 10 transmits the data items of the self-information 10a stored in its memory to the communication mediation means 11 at one time, or specific ones of the data items of the self-information 10a to the communication mediation means 11 sequentially one by one at the third step S13.

Thereafter, at the fourth step S14, the communication mediation means 11 recognizes the self-information 10a of the home appliance 10 transmitted at the above third step S13.

After recognizing the self-information 10a of the home appliance 10, the communication mediation means 11 shares the recognized information with other home appliances connected to the network at the fifth step S15.

Thereafter, at the sixth step S16, upon receiving a control command for the home appliance 10 over an external network, the communication mediation means 11 transmits the received control command to the home appliance 10 such that the appliance 10 is controlled according to the control command.

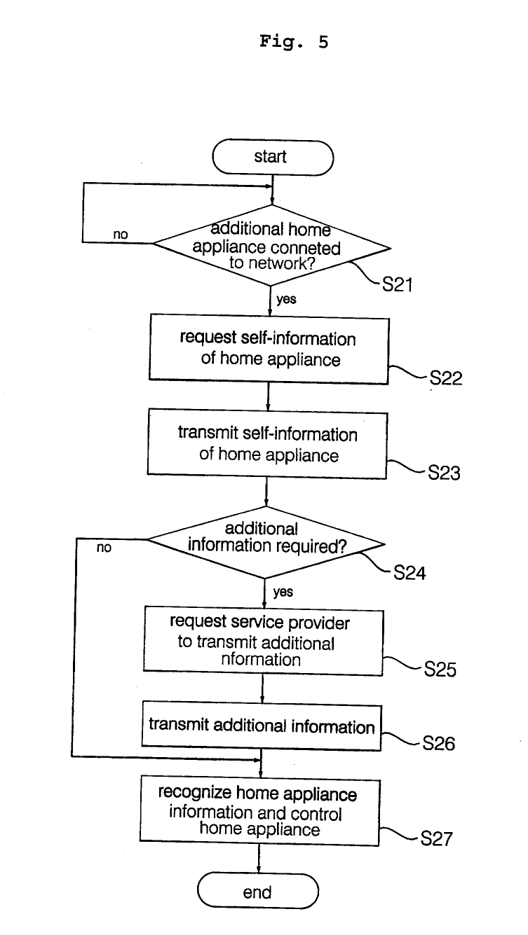

Next, a description will be given of a method for controlling the home appliance networking system with the above-stated construction in accordance with the second embodiment of the present invention with reference to a flow chart of FIG. 5.

First, the communication mediation means 21 continuously monitors at the first step S21 whether there is an additional home appliance 20 powered on and connected to the network. Upon determining at the first step S21 that there is the additional home appliance 20 powered on and connected to the network, the communication mediation means 21 requests the home appliance 20 to transmit its self-information 20a composed of a plurality of data items including a URL of the service provider 22 at the second step S22, so as to recognize the appliance self-information 20a and share the recognized information with other home appliances connected to the network.

At this time, the communication mediation means 21 may request the home appliance 20 to transmit the plurality of data items at one time or sequentially one by one, similarly to the first embodiment of the present invention.

In response to the request from the communication mediation means 21 at the above second step S22, the home appliance 20 transmits the self-information 20a to the communication mediation means 21 at the third step S23.

At the fourth step S24, the communication mediation means 21 recognizes the self-information 20a of the home appliance 20 transmitted at the above third step S23 and then determines whether additional information regarding the appliance 20 is required besides the self-information 20a.

If the additional information regarding the home appliance 20 is determined to be required at the above fourth step S24, then the communication mediation means 21 accesses the service provider 22 with the model address (URL) contained in the self-information 20a and requests it to transmit the additional information at the fifth step S25.

In response to the request from the communication mediation means 21 at the above fifth step S25, the service provider 22 transmits the additional information of the home appliance 20 to the communication mediation means 21 at the sixth step S26. At the seventh step S27, the communication mediation means 21 recognizes the additional information of the home appliance 20 transmitted at the sixth step S26 and the self-information 20a of the appliance 20 transmitted at the third step S23. Thereafter, upon receiving control data for the home appliance 20 over an external network, the communication mediation means 21 transmits the received control data to the home appliance 20 such that the appliance 20 is controlled according to the control data.

As described above, if a new home appliance is connected to a network to which other home appliances remain connected, communication mediation means requests the new home appliance to provide its self-information and, if necessary, a service provider, which stores additional information regarding the new appliance other than the self-information, to provide the additional information. Then, the communication mediation means recognizes the provided information and shares the recognized information with other home appliances connected to the network. Therefore, whenever a new home appliance is connected to the network, all the home appliances connected to the network need not exchange their information data with one another, resulting in a reduction in data traffic of the network.

As apparent from the above description, the present invention provides a home appliance networking system and a method for controlling the same, wherein at least one home appliance is connected to a network and controlled in response to control information received over the network and transmits its state information and self-information over the network, communication mediation means is connected to the home appliance to recognize the self-information transmitted from the home appliance and manage transmission and reception of all data over the network by the appliance on the basis of the recognized information, and a service provider provides additional information regarding the home appliance, not included in the self-information of the appliance, to the communication mediation means. If a new home appliance is connected to the network to which other home appliances remain connected, the communication mediation means recognizes all information of the new home appliance and manages transmission and reception of all data over the network by the appliance on the basis of the recognized information. As a result, whenever a new home appliance is connected to the network, it need not exchange data with other home appliances connected to the network, thereby enabling data to be efficiently transmitted and received over the network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A home appliance networking system comprising:
at least one home appliance connected to a network, said home appliance being controlled in response to control information received over said network and transmitting its state information and self-information over said network; and
communication mediation means connected to said home appliance for recognizing said self-information transmitted from said appliance and managing transmission and reception of all data over said network by said appliance on the basis of the recognized information.

2. The home appliance networking system as set forth in claim 1, further comprising a service provider for providing additional information regarding said home appliance, not included in said appliance self-information, to said communication mediation means in response to a request therefrom.

3. The home appliance networking system as set forth in claim 1, wherein said self-information of said home appliance includes basic information for notifying other home appliances connected to said network and said communication mediation means of the existence of said home appliance.

4. The home appliance networking system as set forth in claim 1, wherein said self-information of said home appliance includes:
an appliance name indicative of a product type of said home appliance;
an appliance nickname indicative of a representative specific function of said home appliance;
a version name indicative of a version of a software program associated with an operation and control of said home appliance;
a manufacturer of said home appliance;
a brand name of said home appliance offered for sale to the public;
a model number uniquely assigned to said home appliance;
a model address that is a uniform resource locator of a service provider which stores additional information regarding said home appliance; and
a coding method for storage of said additional information regarding said home appliance in said service provider.

5. The home appliance networking system as set forth in claim 1, wherein a new data item is added to said self-information of said home appliance or an existing data item is deleted therefrom according to a given situation.

6. A method for controlling a home appliance networking system, comprising the steps of:
a) allowing communication mediation means managing transmission and reception of data over a network to determine whether there is a new home appliance connected to said network and, if there is the new home appliance connected to said network, request said new home appliance to transmit its self-information;
b) allowing said home appliance to transmit its self-information to said communication mediation means in response to the request therefrom; and
c) allowing said communication mediation means to recognize said self-information transmitted from said home appliance.

7. The method as set forth in claim 6, wherein said step b) includes the step of sequentially transmitting said self-information of said home appliance to said communication mediation means in response to the request therefrom.

8. The method as set forth in claim 6, wherein said self-information of said home appliance includes a plurality of data items; and
wherein said step b) includes the step of transmitting said data items to said communication mediation means at one time in response to the request therefrom.

9. The method as set forth in claim 6, further comprising the step of:
d) controlling said home appliance according to control information transmitted over an external network after said step c) is performed.

10. The method as set forth in claim 6, further comprising the steps of:
d) allowing said communication mediation means to request a service provider storing additional information regarding said home appliance, not included in said appliance self-information, to transmit said additional information after said step c) is performed;
e) allowing said service provider to transmit said additional information regarding said home appliance to said communication mediation means in response to the request therefrom; and
f) allowing said communication mediation means to recognize said additional information transmitted from said service provider.

11. The method as set forth in claim 10, wherein said self-information of said home appliance includes a uniform resource locator of said service provider storing said additional information regarding said home appliance; and
wherein said step d) includes the step of requesting said service provider with said uniform resource locator of said self-information to transmit said additional information regarding said home appliance.

12. The method as set forth in claim 10, wherein said step e) includes the step of sequentially transmitting said additional information regarding said home appliance to said communication mediation means in response to the request therefrom.

13. The method as set forth in claim 10, wherein said additional information regarding said home appliance includes a plurality of data items; and
wherein said step e) includes the step of transmitting said data items to said communication mediation means at one time in response to the request therefrom.
